(19) United States
(12) Patent Application Publication
(10) Pub. No.: US 2022/0396525 A1
(43) Pub. Date: Dec. 15, 2022

(54) METHOD FOR THE PRODUCTION OF GRANULAR MATERIALS DESIGNED TO BE USED FOR MANUFACTURING ARTICLES IN SLAB OR BLOCK FORM FROM A MIX

(71) Applicant: Luca Toncelli, Bassano del Grappa (VI) (IT)

(72) Inventor: Luca Toncelli, Bassano del Grappa (VI) (IT)

(21) Appl. No.: 17/762,827

(22) PCT Filed: Oct. 13, 2020
(86) PCT No.: PCT/IB2020/059591

§ 371 Date: Mar. 23, 2022

(30) Foreign Application Priority Data
Oct. 15, 2019 (IT) 102019000018890

(51) Int. Cl. C04B 18/02; C04B 18/16; C04B 14/06; C04B 14/30; C04B 16/00; C04B 40/00; C04B 40/02

(52) U.S. Cl. CPC C04B 18/026; C04B 18/167; C04B 14/06; C04B 14/304; C04B 14/303; C04B 14/306; C04B 16/00; C04B 40/0067; C04B 40/0259; C04B 40/0272

(57) ABSTRACT

Method for the production of granular materials designed to be used as aggregates and fillers in a mix containing a binder for the manufacture of articles in slab or block form. The method comprises a step of melting a mixture of selected minerals having a specific chemical composition, a step of casting the molten material, a step of cooling the cast material until a predetermined temperature is reached and a step of crushing and/or grinding the cooled material to obtain granular materials having a selected particle size and suitable for use as aggregates or fillers in the mix for the manufacture of articles in slab or block form. Moreover, the method comprises, upstream of the melting step, a step for recovery and collection of the manufacturing waste of other previously manufactured articles. The manufacturing waste is designed to compose at least partially the mixture of selected minerals. The invention also relates to a method for manufacturing articles in slab or block form from a mix containing the aggregates and the fillers and a binder.

The present invention relates to a method for the production of granular materials intended to be used, in the form of aggregates or fillers, for the manufacture of articles in slab or block form from a mix.

In particular, the granular materials obtained by means of the method of the present invention are formed mainly by calcium silicates substantially devoid of silicon dioxide in crystalline form, namely with a content of silicon dioxide in crystalline form of less than 1%. Moreover, the aggregates and fillers have a stone or stone-like appearance and the mix used to produce the articles comprises, in addition to the aggregates and fillers, also an organic or inorganic hardening binder.

The material of the articles obtained, namely the slabs or blocks, is thus formed by composite stone.

The invention also relates to a method for the manufacture of articles from the aggregates and fillers described above.

The articles produced from a mix may be made, in a manner known per se, by means of rolling, pressing, extrusion or for example by means of a procedure known also as Bretonstone® technology.

In this procedure, a mix formed by granular stone or stone-like material for the manufacture of the aggregates and fillers, and a binder, for example a hardening resin, is initially arranged on a temporary support or mould; then the mix is subjected to vibration with simultaneous pressing or compression under a vacuum (vacuum vibrocompression) and then hardening of the mix is performed.

The material of the aggregates normally consists of natural minerals which may be of a siliceous natures, such as quartz, cristobalite, granites, porphides, basalt, quartzites, or of a calcareous nature, such as marbles, dolomites and coloured stones.

The fillers instead are materials used in combination with the binder to form the so-called “binding paste” and normally consist of stone materials in powder form of varying kinds, such as ventilated quartz or ventilated feldspar in combination with siliceous aggregates or calcium carbonate, or aluminium hydroxide in combination with aggregates of a calcareous nature.

The mix may also comprise additives and colouring agents for obtaining articles which have special aesthetic effects, for example veining.

Among the various types of materials used to produce the aggregates and fillers, ground quartz, in the form of sand or fine powder respectively, are widely distributed commercially in the sector.

In fact, owing to the transparency of the quartz, it is possible to obtain articles which have a very attractive appearance, are extremely scratch-resistant and/or abrasion-resistant and are resistant to chemical agents such as acids which are commonly used.

Cristobalite, which is opaque and has a deep white colour, is also widely used in the sector.

Despite the fact that they are widely used, these solutions are not without a number of drawbacks.

For example, one drawback considered to be particularly serious in the sector is the fact the use of materials such as quartz, cristobalite, quartzites or siliceous sands for the manufacture of the aggregates and fillers results in the formation of powders of silicon dioxide (SiO₂) in the crystalline state during the production and manufacture of the article obtained from the aggregates and fillers.

These powders, when dispersed in the atmosphere, may be very harmful for human beings, in particular the workers at the manufacturing plant, if inhaled, resulting in a disease called silicosis which may also develop cancerogenous forms.

In order to overcome, at least partially, this drawback, a number of measures may be taken, in particular:
equipping the workers involved in processing the articles with special individual protection devices, so-called IPDs;
washing down with water the working zone, in particular the zone where the machining tool comes into contact with the article; this measure prevents the powders containing crystalline silica from being dispersed in the air.
the use of dust capturing equipment.

However, not always are these measures adopted, and therefore there is the need to manufacture an article which has the desired mechanical and/or chromatic properties, but which is able to avoid the formation and dispersion of powders containing silicon dioxide in crystalline form, which is harmful for the workers during the entire manufacturing step.

For example, the patent application WO2018/189663 discloses a method for the production of articles in slab or block form with a stone-like appearance which uses aggregates or fillers substantially devoid of silicon dioxide in crystalline form.

These synthetic aggregates or fillers may consist of a special amorphous glass, referred to in technical jargon as “frit”, which is very hard and semi-transparent, with an appearance similar to that of quartz; in these aggregates or fillers, the silicon dioxide in crystalline form may be present only in very small amounts of less than 1%.

The method for the production of these aggregates and fillers initially involves melting a mixture of selected natural minerals inside a melting furnace; then the molten material is cooled, generally rapidly and with water (using a process known as “fritting”), or by means of air, and then dried, ground and separated into the desired granulometric fractions.

The aggregates and fillers thus produced have a hardness equal to or greater than 5 Mohs and may form at least 70% of the overall weight of the mix for manufacture of the articles.

The technologies described above, although very popular in the sector, are not without a number of drawbacks.

A first drawback consists in the fact that the manufacture of the articles obtained from the aggregates and the fillers described above produces large quantities of manufacturing reject material and waste which must be disposed of.

In particular, the manufacturing waste consists both of sludges, namely the watery dispersions of powders of the material and binder which form the articles, and of uncompacted mix waste and large fragments of the hardened articles.

This manufacturing waste must be disposed of by means of specific and regulated procedures which usually have a particularly high cost.

Another drawback consists in the fact that the mineral components of the mixture intended to undergo the melting step have a given cost which affects the final cost of the article.

A further drawback consists in the fact that the step of melting the mineral mixture uses a particularly large amount of energy and the melting furnace has a particularly high energy consumption.

In order to overcome at least partially these drawbacks, methods for recovery of the manufacturing waste have been developed.

For example, IT1381133 discloses a method for the recovery of the sludges resulting from the manufacture of articles made of agglomerate material, which is able to obtain ventilated powders and fillers which may be reused in further article production processes.

However, the fillers and the powders thus obtained are not used in methods for the manufacture of articles with a reduced content of silicon dioxide in crystalline form.

The object of the present invention is to solve essentially the drawbacks of the prior art and overcome the known limitations by providing a method for the production of granular materials obtained from manufacturing waste and designed to be used as aggregates and fillers for the manufacture of articles from a mix.

A particular task of the present invention is to provide a method for the production of granular materials for the manufacture of articles which is able to recover waste resulting from the manufacture of other previously manufactured articles.

In particular, the object of the present invention is to provide a method for the production, from manufacturing waste of other previously manufactured articles, of granular materials substantially devoid of silicon dioxide in crystalline form, to be used as aggregates and fillers in a mix containing a binder for the manufacture of articles in slab or block form.

Another task of the present invention is to provide a method for the production of granular materials which has a low cost compared to the known methods in the sector.

A further task of the present invention is to provide a method for the production of granular materials which allows the overall energy consumption to be reduced.

Another task of the present invention is to provide a method for the manufacture of articles from a mix containing a binder and aggregates and fillers substantially devoid of silicon dioxide in crystalline form, which is able to reduce the cost of the finished article.

The aforementioned object and tasks are achieved with a method for the production of granular materials substantially devoid of silicon dioxide in crystalline form and suitable for user as aggregates or fillers for the manufacture of articles from a mix according to claim 1 and using a method for the manufacture of articles consisting of a material obtained from a mix containing aggregates and fillers according to claim 13.

In the present text, a method for the production of granular materials designed to be used as aggregates and fillers in a mix containing a binder for the manufacture of articles in slab or block form is described.

The binder is a hardening binder and may be of the organic or inorganic type, as known from the prior art; the binder is suitable for being mixed with the fillers in order to obtain a binding paste.

The mix may also comprise additives and colouring agents for obtaining articles which have special aesthetic effects, for example veining.

The method involves in particular obtaining aggregates and fillers from a particular mixture of minerals having a specific chemical composition.

The chemical composition of the mineral mixture may be the following:
a quantity by weight of SiO₂ comprised between 43% and 80%;
a quantity by weight of CaO comprised between 5% and 30%;
a quantity by weight of MgO comprised between 0% and 12%;
a quantity by weight of Al₂O₃ comprised between 0% and 25%;
a quantity by weight of ZrO₂ comprised between 0% and 20%;
a quantity by weight of Na₂O comprised between 0% and 12%; and
a quantity by weight of K₂O comprised between 0% and 10%;

Alternatively the specific chemical composition of the mineral mixture may be the following:
a quantity by weight of SiO₂ comprised between 48% and 73%;
a quantity by weight of CaO comprised between 12% and 30%;
a quantity by weight of MgO comprised between 1.5% and 11%;
a quantity by weight of Al₂O₃ comprised between 1% and 19%; and
a quantity by weight of ZrO₂ comprised between 0% and 20%.

Optionally the mixture may also contain oxides in the following weight ranges:
0%<B₂O₃<10%;
0%<ZnO<10%.
0%<BaO<10%;
0%<Li₂O<5%;
0%<OF, <10%; and
0%<P₂O₅<5%.

One or more chromophores may also be present in the mixture. However the quantity of chromophores must be particularly small so as not to alter in a significant manner the aesthetic appearance of the article; for this reason, the aforementioned chemical composition may also comprise the weight ranges:
Fe₂O₃<0.1%; and
TiO₂<0.1%.

The aforementioned ranges are to be understood as weight amounts with respect to the overall weight of the mineral mixture.

Thereafter, following vacuum vibrocompression of the mix containing the binder, the aggregates and/or the fillers, and hardening of the binder, the finished articles are obtained.

In order to perform hardening, the article is transferred into a catalysis oven in the case where the mix contains a resin as binder, or is left to mature in the case where the mix contains a cementitious binder.

In a preferred embodiment of the invention, the method for the production of granular materials comprises the following steps:
melting a suitably formulated mixture of selected minerals having a specific chemical composition, of the type indicated above, to obtain a molten material C suitable for being cast;
casting the molten material;
cooling the cast material to a predetermined temperature;
crushing and/or grinding the cooled material to obtain granular materials having a selected particle size and designed to be used as aggregates and fillers in the mix for manufacturing the articles in slab or block form.

Suitably the melting step may be performed by means of introduction of the mixture of selected minerals inside a melting furnace and the melting temperature of the minerals inside the melting furnace is between 1500° C. and 1600° C., preferably close to 1550° C. In fact, after the melting step, the material obtained from the mixture of molten materials has an amorphous configuration.

The cooling step may be performed using water so as to bring the molten material to the predetermined temperature, for example a temperature close to room temperature.

In particular, the molten and cast material from the melting furnace is struck directly by water jets located at the outlet of the melting furnace in order to perform the cooling step. Alternatively, the molten material may be rapidly air-cooled.

Before undergoing the grinding and/or crushing step for manufacture of the granular materials, the cooled material undergoes a further drying step in order to remove the water.

Moreover, if granular materials with a deep, intense, white colour are to be obtained, the cooled material may be subjected to a recrystallization step.

This latter step is performed by heating and keeping the material from the cooling step at a predetermined temperature, preferably of between 1030° C. and 1170° C., for a predetermined time of between 15 and 25 minutes.

At the end of the process, the material is ground by means of suitable grinding means, of the type known per se in the prior art, with varied particle sizes depending on the use for the production of the mix, or as aggregates or as fillers.

According to a particular aspect of the invention, the method involves, upstream of the melting step, a step for recovering and collecting the manufacturing waste of other previously manufactured articles also formed by aggregates and fillers with a binder, of the organic or inorganic type.

The manufacturing waste is designed to compose at least partially the mixture of selected minerals which undergoes the melting step.

The articles from which the manufacturing waste is obtained may themselves be obtained by means of the method according to the present invention, namely using minerals derived from manufacturing waste, or using mixtures of natural minerals, namely minerals which are not derived from manufacturing waste, or non-natural minerals.

Moreover, the manufacturing waste must have a chemical composition suitable for composing the mixture of selected minerals, derived wholly or partly from manufacturing waste and optionally consisting partly of natural or non-natural minerals.

This composition must fall within the weight ranges indicated above for the mixture of selected minerals so that at the end of the production process the granular materials obtained have a hardness of at least 5 Mohs and a content of silicon dioxide in crystalline form of less than 1%.

In particular, the granular materials obtained with the method described above consist of calcium silicates and form an amorphous vitreous material, referred to as “frit”.

The frit has a chemical composition which falls within the weight ranges of the components indicated above for the mixture of selected minerals and has an appearance similar to cristobalite or quartz, but a content of silicon dioxide in crystalline form of less than 1%.

For this reason, the articles obtained from these aggregates and fillers also have the advantage of preventing the formation of cristobalite and quartz powders during processing thereof.

The manufacturing waste, which is produced from the processing of other articles previously manufactured using natural or non-natural granular materials or obtained from manufacturing waste, may comprise sludges, uncompacted mixes or fragments of the hardened article.

The sludges comprise the watery dispersions of powders of the material and binder forming the previously manufactured articles; the water represents about 35% by weight of the overall weight of the sludges.

The water of the sludges consists of the cooling water used to cool the tools of the sizing and smoothing machines and optionally also cutting and milling machines, used for the machining of the articles.

The sludges must undergo a prior drying step so as to obtain the powders which will be used to form at least partially the mixture of selected minerals which undergoes the melting step.

The uncompacted mix waste is derived from the so-called “heads” and “tails” which are formed during the article manufacturing process. This waste, after being suitably hardened, and the fragments obtained directly from the finished articles must be further fragmented and/or ground in order to obtain mineral powders and binder powders which are used to form the mixture of selected minerals.

Regardless of the physical nature of the machining waste, it must be substantially devoid of—or in any case have a reduced content of—metals as regards it chemical composition.

In fact, the presence of metals may alter the final colouring of the aggregates and the fillers obtained by means of the production method, and therefore also the colouring of the articles produced from the aggregates and the fillers.

In order to reduce or eliminate the presence of metals in the chemical composition of the machining waste, the following measures may be taken during the manufacture of the articles from which the machining waste is obtained:
use, during manufacture of the articles, organic pigments instead of inorganic pigments, which burn during the process of melting the mixtures obtained from the machining waste;
use catalysts for hardening of the binder, i.e. the resin, which do not contain cobalt or other metals;
use tools for the sizing and smoothing of the articles which have a minimum release of metals during the machining operations.

Moreover, the chemical composition of the machining waste may be different among different production batches or also within the same production batch.

For this reason, the chemical composition of the mixture of selected minerals must be reformulated and adjusted in each case depending on the chemical composition and the characteristics of the frit which is to be obtained.

For this purpose, the method may involve a step of adding natural mineral powders, i.e. mineral powders not derived from manufacturing waste, to the mixture of selected minerals which undergoes melting, so as to have a chemical composition suitable for obtaining the desired characteristics of the granular materials.

Therefore, the mixture of selected minerals may comprise a predetermined quantity of minerals and binder derived from machining waste in powder form and a predetermined quantity of natural mineral powders which are added separately.

Moreover, in the case of a binder of the organic type, the pulverized fragments of resin of the machining waste burn during the mineral mixture melting process: therefore these fragments are completely eliminated and the final composition of the frit does not comprise traces of resin.

Therefore, before melting of the mixture of selected minerals, the combustion of the organic binder obtained from the machining waste is performed.

The above description clearly highlights the advantages which can be obtained with the method according to the present invention compared to the conventional methods for the production of granular materials suitable for use as aggregates and fillers.

Firstly, with the method it is possible to obtain granular materials for the manufacture of aggregates and fillers substantially devoid of silicon dioxide in crystalline from machining waste, which otherwise would be disposed of with a significant increase in the overall production costs.

Moreover, the use of minerals derived from machining waste for formation of the mixture of selected materials allows the manufacturer to limit the acquisition of natural minerals, with significant savings as regards the final cost of the finished article.

Furthermore, the use of machining waste with organic binder for the formation of the mixture of natural minerals results in an—at least partial—reduction of the energy consumption, in particular during the melting step. In fact, during melting of the resin in the machining waste, the organic binder burns, releasing heat and acting as it were a fuel.

The person skilled in the art, in order to satisfy specific needs, may make modifications to the embodiments described above and/or replace the elements described with equivalent elements, without thereby departing from the scope of the attached claims.

1. Method for the production of granular materials designed to be used as aggregates and fillers in a mix containing a binder for the manufacture of articles in slab or block form, comprising the following steps:
melting a mixture of selected minerals having a specific chemical composition for obtaining a molten material;
casting the molten material;
cooling the cast material to a predetermined temperature;
crushing and/or grinding the cooled material to obtain granular material having a selected particle size and suitable for being used as aggregates or fillers in the mix for manufacturing the articles in slab or block form;
wherein said method comprises, upstream of said melting step, a step for recovering and collecting the manufacturing waste of other previously manufactured articles consisting of aggregates and fillers with a binder, said manufacturing waste being designed to compose at least partially said mixture of selected minerals;
characterized in that, before melting said mixture of selected minerals, the combustion of the organic binder which may be present in the manufacturing waste is performed.

2. Method according to claim 1, characterized in that the granular materials obtained by means of said method comprise calcium silicates with a content of silicon dioxide in crystalline form of less than 1%.

3. Method according to claim 1, characterized in that said manufacturing waste is composed of sludges comprising mineral powders and binder powders dispersed in water.

4. Method according to claim 3, characterized in that said sludges are subjected to a drying step in order to obtain dried powders of minerals and binder to be used in the mixture of selected minerals.

5. Method according to claim 1, characterized in that said manufacturing waste consists of a uncompacted mix and fragments derived from the manufacture of other articles.

6. Method according to claim 5, characterized in that said uncompacted mix waste or fragments of these other articles are subjected to a preliminary grinding step in order to obtain powders to be used in the mixture of selected minerals.

7. Method according to claim 1, characterized in that said mixture of selected minerals is formed by a predetermined quantity of minerals derived from manufacturing waste in powder form and from a predetermined quantity of natural mineral powders.

8. Method according to claim 1, characterized in that the manufacturing waste is substantially devoid of metals.

9. Method according to claim 1, characterized in that said cooling step is performed using water until the molten and cast material reaches room temperature.

10. Method according to claim 1, characterized in that the chemical composition of the mineral mixture comprises:
a quantity by weight of SiO₂ comprised between 48% and 73% of the overall weight of the mineral mixture;
a quantity by weight of CaO comprised between 12% and 30% of the overall weight of the mineral mixture;
a quantity by weight of MgO comprised between 1.5% and 11% of the overall weight of the mineral mixture;
a quantity by weight of Al₂O₃ comprised between 1% and 19% of the overall weight of the mineral mixture; and
a quantity by weight of ZrO₂ comprised between 0% and 20% of the overall weight of the mineral mixture.

11. Method according to claim 1, characterized in that the chemical composition of said mixture of selected minerals comprises:
a quantity by weight of SiO₂ comprised between 43% and 80% of the overall weight of the mineral mixture;
a quantity by weight of CaO comprised between 5% and 30% of the overall weight of the mineral mixture;
a quantity by weight of MgO comprised between 0% and 12% of the overall weight of the mineral mixture;
a quantity by weight of Al₂O₃ comprised between 0% and 25% of the overall weight of the mineral mixture;
a quantity by weight of ZrO₂ comprised between 0% and 20% of the overall weight of the mineral mixture;
a quantity by weight of Na₂O comprised between 0% and 12% of the overall weight of the mineral mixture; and
a quantity by weight of K₂O comprised between 0% and 10% of the overall weight of the mineral mixture.

12. Method according to claim 1, characterized in that said manufacturing waste comprises organic pigments designed to burn during melting of the mineral mixture.

13. Method for manufacturing articles in slab or block form using a mix containing a binder and aggregates and fillers obtained by means of the method according to any one of claims 1-12, the method comprising the following steps:
arrangement of the mix on a support;
vacuum vibrocompression of the mix contained in the support;
hardening of the binder.
